(19) United States
(12) Patent Application Publication
(10) Pub. No.: US 2013/0346066 A1
(43) Pub. Date: Dec. 26, 2013

(54) Joint Decoding of Words and Tags for Conversational Understanding

(71) Applicants: Anoop Kiran Deoras, San Jose, CA (US); Dilek Zeynep Hakkani-Tur, Los Altos, CA (US); Ruhi Sarikaya, Redmond, WA (US); Gokhan Tur, Los Altos, CA (US)

(72) Inventors: Anoop Kiran Deoras, San Jose, CA (US); Dilek Zeynep Hakkani-Tur, Los Altos, CA (US); Ruhi Sarikaya, Redmond, WA (US); Gokhan Tur, Los Altos, CA (US)

(73) Assignee: MICROSOFT CORPORATION, Redmond, WA (US)

(21) Appl. No.: 13/528,124

(22) Filed: Jun. 20, 2012

(51) Int. Cl. G06F 17/27; G10L 15/00

(52) U.S. Cl. 704/9; 704/E15.001

(57) ABSTRACT

Joint decoding of words and tags may be provided. Upon receiving an input from a user comprising a plurality of elements, the input may be decoded into a word lattice comprising a plurality of words. A tag may be assigned to each of the plurality of words and a most-likely sequence of word-tag pairs may be identified. The most-likely sequence of word-tag pairs may be evaluated to identify an action request from the user.

### BACKGROUND

In spoken language understanding systems or spoken dialog systems, the ultimate goal is to understand the meaning of the speaker's utterance, not simply to provide speech recognition output. Conventional speech recognition applications experience a high error rate in real world settings. Some reasons for this include environmental and channel noise, speaker accent, inherent ambiguity in speech, modeling, and search limitations. As such, an automatic speech recognition (ASR) module's output always contains uncertainty and errors if the ASR module produces a 1-best hypothesis/output. That is, each module of the spoken language understanding system makes a best guess based on its input and passes that guess as an output to the next module without including any uncertainty factors or other possibilities. In most conventional approaches, a conversational understanding system employs a cascade approach, where the best hypothesis from an input recognizer is fed into a language understanding module, whose best hypothesis is then fed into interpreters and/or dialog managers. A hard decision made at each stage (i.e., keeping only 1-best) has a detrimental effect on the downstream components (e.g., spoken language understanding, dialog belief state tracking, dialog policy execution) not only by propagating errors from one statistical module to the next but also compounding it.

### SUMMARY

This Summary is provided to introduce a selection of concepts in a simplified form that are further described below in the Detailed Description. This Summary is not intended to identify key features or essential features of the claimed subject matter. Neither is this Summary intended to be used to limit the claimed subject matter's scope.

Joint decoding of words and tags may be provided. Upon receiving an input from a user comprising a plurality of elements, the input may be decoded into a word lattice comprising a plurality of words. A tag may be assigned to each of the plurality of words and a most-likely sequence of word-tag pairs may be identified. The most-likely sequence of word-tag pairs may be evaluated to identify an action request from the user.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIGS. 2A-2C are illustrations of an example word lattice;

FIG. 3 is a flow chart of a method for providing joint decoding of words and tags; and

FIG. 4 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

In conversational understanding applications, input understanding may apply to identifying a user's intent in addition to simply recognizing the input. Users may provide input to devices such as microphones, tablets, or cameras in ‘real world’ style rather than as specialized queries. For example, players of a game may issue commands to the game console as they would issue spoken orders, or a driver may ask their navigation device to find directions to a place as they would to a fellow passenger. As such, inputs in the form of speech, written text, and/or gestures may be supplied by a user. An input recognizer may transcribe these inputs into a text-based form that can be understood and processed by the conversational understanding application. For example, a spoken input may be transcribed by an automatic speech recognizer (ASR) from a string of spoken words into a string of text words. Similarly, a gesture and/or handwriting recognizer may transcribe those inputs into text strings. The ASR may use a statistics-based acoustic model to identify the most-likely text words that map to the spoken inputs. Such a model may take into account conditions such as the speaker's accent, background noise, and training and/or learning data acquired from previous uses by the speaker.

Once the input is transcribed into text, a language understanding module may receive the text-based input to try and assign contextual meanings to each word in the form of semantic tags. Semantic tags may comprise meta-data associated with each recognized word such as a categorization and/or a link to relevant external data. For example, the input phrase ‘list ron howard pictures’, could have semantic tags of ‘actor’ and/or ‘director’ associated with ‘ron howard’ and semantic tags of ‘television’ and ‘movies’ associated with ‘pictures’. The language understanding module may look at the context of the input, such as previous recent inputs, a history of the user's interests, and/or common queries measured across multiple users, and decide that ‘director’ and ‘movies’ are statistically the most-likely tags to be associated with this input. These tags may help refine the input into an executable action, such as a search engine query for ‘movies directed by Ron Howard’, that may be used to provide a result to the user.

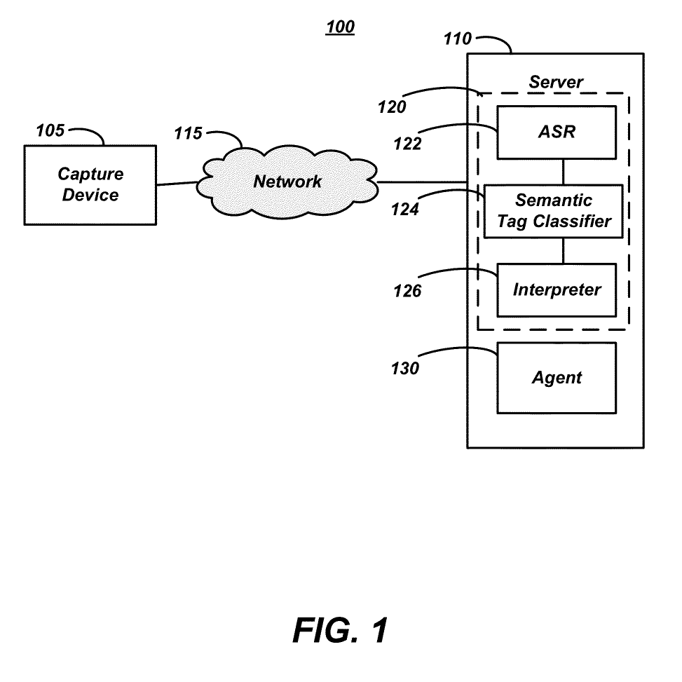

FIG. 1 is a block diagram of an operating environment 100 for providing a joint decoding framework comprising a capture device 105. The joint decoding framework allows for semantic tagging of multiple possible word sequences to produce a word-tag sequence output from a given input.

Capture device 105 may comprise, for example, an electronic user device such as a computer, laptop, tablet, cellular phone, game console, smart phone, or other similar device. In some embodiments, capture device 105 may comprise a separate component coupled to a computing device such as a camera and/or microphone. For example, capture device 105 may comprise a Microsoft® Kinect® sensor comprising a plurality of cameras and microphones. Capture device 105 may be operative to capture inputs from a user such as spoken words, gestures, and/or text inputs and provide those inputs to server 110 via a network 115. Server 110 may comprise an input understanding architecture 120 comprising an automatic speech recognizer (ASR) 122, a joint word-semantic tag classifier 124, and an interpreter/knowledge broker 126. Input understanding architecture 120 may receive an input from capture device 105 and transcribe the input into a word-tag sequence as output. Server 110 may further comprise an agent component 130 that may receive the outputs from input understanding architecture 120 and perform actions according to those outputs. For example, a user's input may be translated into a search engine queries, requests for information, instructions, commands, etc. that may be executed by agent component 130 to provide results to the user.

Consistent with embodiments of the invention, other configurations may be used to accomplish the concepts described in this disclosure. For example, input understanding architecture 120 may execute on capture device 105 directly rather than on a separate server and/or agent 135 may execute on capture device 105 and/or another computing device in communication with server 110 via network 105.

In a cascade approach to spoken language understanding, a most-likely word sequence may be identified by ASR 122 before this output is fed into semantic tag classifier 124 to identify a most-likely tag sequence.

In a joint decoding framework, however, ASR 122 may identify multiple possible word sequences, such as by identifying each of the most-likely text-based words for each word in a spoken input. For example, a statistical model associated with ASR 122 may identify the words ‘wear’ and ‘where’ with equal statistical confidence for the same spoken input. Thus, the joint decoding approach may take acoustic modeling into account to model a joint distribution of words and tags. That is, a pair of sequences may be identified comprising words and tags that jointly maximizes the posterior probability of a resulting word-tag sequence for a given input signal.

Each of these word sequences may then be evaluated by semantic tag classifier 124, which may use a statistical model of its own to assign semantic tags to each word in each possible sequence. These tags may also have a statistical confidence that may take into account the left, or previous word, and right, or next word, contexts. Because of this, the word sequences may be provided to semantic tag classifier 124 by ASR 122 with unambiguous right and left contexts in the form of a word lattice. This word lattice may provide a series of arcs and nodes, wherein the arcs are associated with each possible recognized word for a given input word and the nodes maintain the connection between the alternative words in each sequence.

Thus, rather than trying to process a word sequence from ASR 122 where the previous and next words are indicated as one of multiple possibilities (i.e., an ambiguous context), the word lattice allows semantic tag classifier 124 to evaluate multiple possible word sequences such that each node, or word transition, in a given sequence has an unambiguous context of the word possibilities on both the left incoming arc and the right outgoing arc.

The word lattice allows uncertainty in ASR 122 to be propagated to semantic tag classifier 124 rather than relying on a 1-best hypothesis by ASR 122. A probability may be assigned for a word on an arc and a tagging model probability may be assigned for a tag given the context of previous and/or next words and their associated tags. The propagated word lattice may maintain unambiguous left context at each arc by expanding each possible word from the ASR from left to right. The word lattice may then be reversed and the process repeated to create an unambiguous right context before reversing the word lattice again to the lattice's original orientation. Once the expanded word lattice is obtained, it may be traversed in a topological order. At each arc, the unambiguous word context (left and right) may be extracted and for every possible tag on the previous arc, a distribution may be obtained over all tags on the current arc using a machine learning algorithm such as a maximum entropy model, a support vector machine, a neural network, conditional random fields, boosting, etc. By way of example, but not limitation, a Viterbi decoding algorithm may be used to obtain a best path resulting in the output word-tag sequence. In statistical parsing, a dynamic programming algorithm known as Viterbi decoding may be used to discover the single most-likely context-free derivation (parse) of a string. Such a Viterbi decoding may be implemented such that for any word arc in the lattice and for every slot type on that arc, the best incoming word-slot pair transition is remembered by evaluating all possible slots on all previous word arcs. This decoding may be used to find an optimal path comprising words and tags in the lattice such that the joint probability is maximized given acoustics.

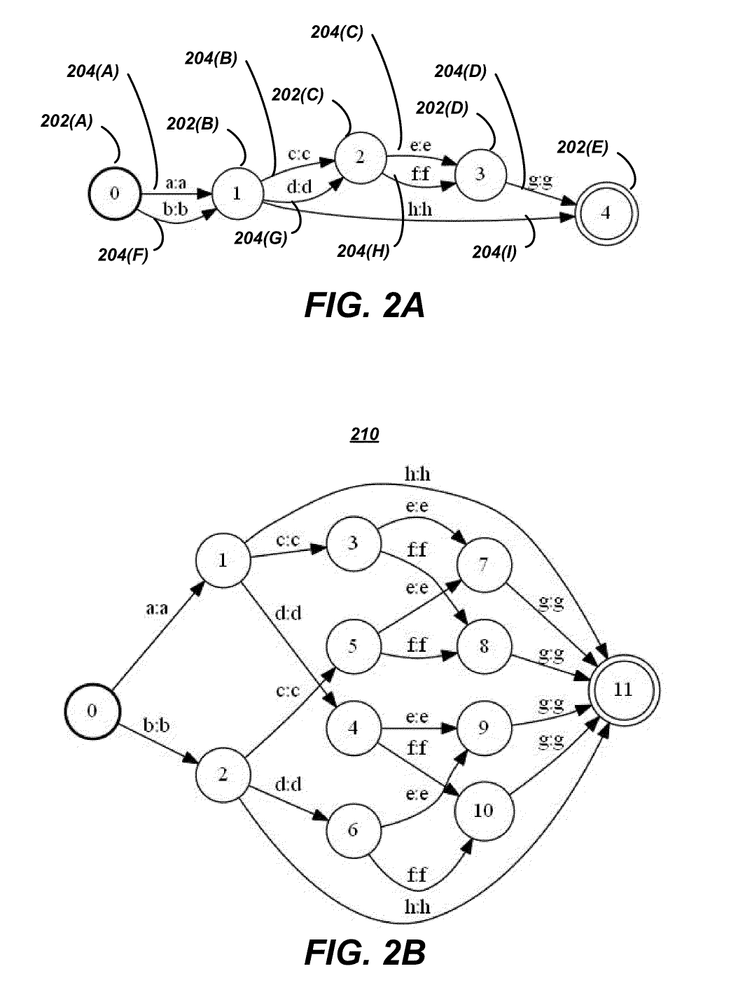

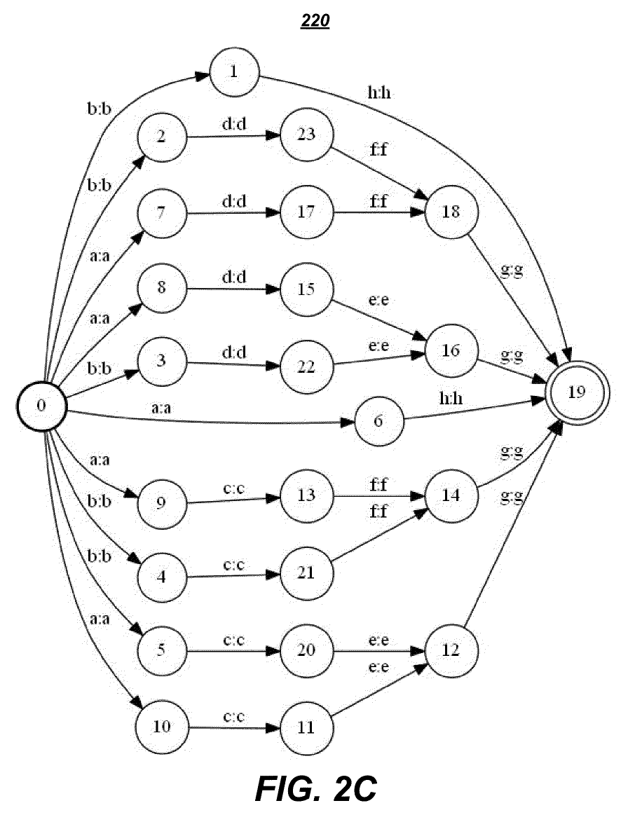

FIG. 2A illustrates an example word lattice 200 prior to expansion and resolution of ambiguity. Example word lattice 200 may comprise a directed acyclic graph and comprises a plurality of nodes 202(A)-(E) comprising word transitions between plurality of word possibility arcs 204(A)-(I). A word transition node having arcs that represent multiple word possibility arcs is said to have an ambiguous context. A word transition node with only one possible word arc thus has an unambiguous context. In order to run statistical models on example word lattice 200, it may be necessary to ensure that each edge has an unambiguous context of ‘n’ words in both the left (previous) and right (next) directions. In some embodiments of the disclosure, n may range from 1 to 3. Example word lattice 200, as depicted in FIG. 2A, does not maintain this property. For example, examining the edge between node 1 and 2 containing the word c shows that edges containing word a and b both merge at node 1 and so the left context for the word c is ambiguous. Similarly, looking at the right context, the presence of e,g and f,g word sub sequences results in an ambiguous context. Thus, in trying to assign probability scores to word possibility c or tag probability scores to arc 204(B) containing the word c, it becomes necessary to expand the lattice to both the right and left of each transition node by splitting the nodes to extract unambiguous left and right contexts. FIG. 2B illustrates a left-expanded example word lattice 210. Left-expanded example word lattice 210 maintains unambiguous left, or previous, word context. For example, each ‘c’ word arc comprises only one word, ‘a’ or ‘b’, at the left node. However, ambiguous right contexts persist, such as word sequences e,g, and f,g on the right for word ‘c’.

FIG. 2C illustrates a right-expanded example word lattice 220 in its fully expanded representation to maintain unambiguous right, or next word, context. Right-expanded example word lattice 220 represents a plurality of possible word sequences, each with unambiguous previous and next words for each current word. For example, the sequence of nodes 0->3->22->16->19 comprises the possible word sequence ‘b’, ‘d’, ‘e’, ‘g’.

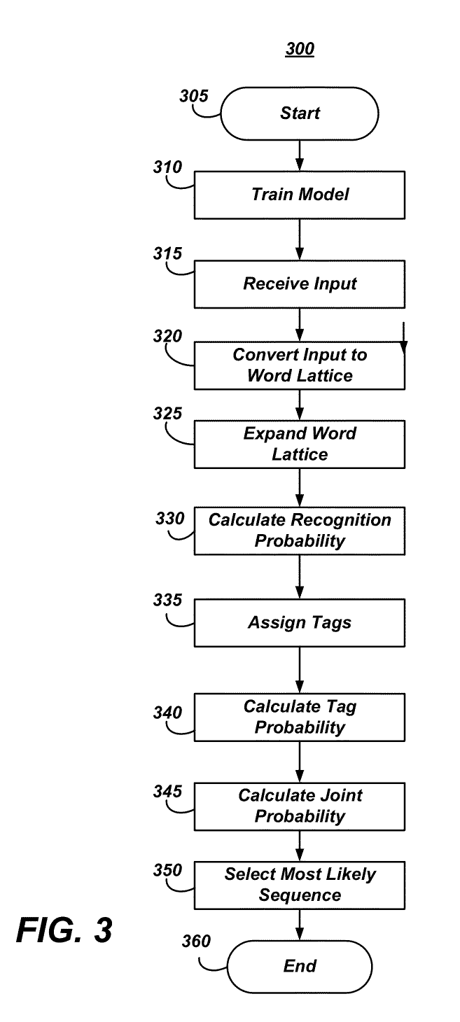

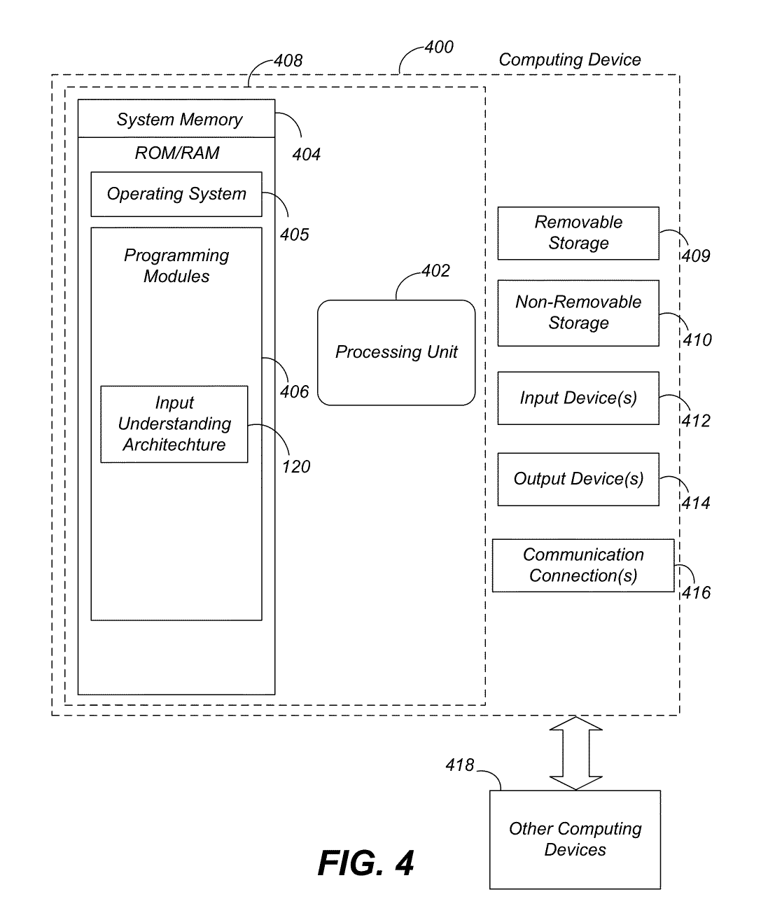

FIG. 3 is a flow chart setting forth the general stages involved in a method 300 consistent with an embodiment of the invention for providing joint decoding of words and tags. Method 300 may be used to enable the transfer of the inherent ambiguities in speech recognition, as described above, to spoken language understanding (SLU) modules and thus aid in avoiding likely wrong hard decisions in the recognized speech to make improved decisions both on the decoded speech and SLU output. Furthermore, the method may allow for the leveraging of SLU evidence to improve speech recognition and vice versa. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may train a statistical model with a plurality of tag probabilities. For example a discriminative model such as a maximum entropy model may be trained to learn posterior probabilities of tags given some finite context of current, past and/or future words and the context of a finite number of next and/or previous tags. Text corresponding to manually transcribed speech data and the corresponding tag sequence may be used for training the maximum entropy model. Similarly, manually annotated tags for these word sequences may be used to train the maximum entropy models.

Method 300 may then advance to stage 315 where computing device 400 may receive an input from a user. For example, the input may comprise an acoustic signal comprising a plurality of elements such as spoken words, a series of gestures, and/or text input by the user on an input device and/or captured by capture device 105.

Method 300 may then advance to stage 320 where computing device 400 may convert the input into a word lattice. For example, an acoustic/spoken input may be passed to automatic speech recognizer (ASR) component 122 while gestures may be passed to a gesture recognizer. The appropriate recognizer may identify a plurality of possible text words to represent each element of the input.

Method 300 may then advance to stage 325 where computing device 400 may expand the word lattice to eliminate both leftward/previous and rightward/next word ambiguities. For example, ASR component 122 may expand the lattice into a plurality of arcs that each represents a possible word sequence, as described above with respect to FIGS. 2A-2C.

Method 300 may then advance to stage 330 where computing device 400 may calculate a recognition probability for each of the possible recognized words. For example, in right-expanded example word lattice 220, confidence in recognition of word ‘e’ may be 30% while confidence in recognition of word ‘f’ may comprise 70%. Applying context according to previous word ‘c’ and/or next word ‘g’, however, may result in a higher confidence for word ‘e’ if word ‘e’ more often follows word ‘c’ and/or more often proceeds word ‘g’ than does word ‘f’. Tags assigned to each word, as described below with respect to stage 335, may also be used in defining the context for the word. For example, by applying the context of previous word ‘c’, next word ‘g’, and a tag associated with previous word ‘c’, a higher (or lower) confidence may result for word ‘e’ than if the context did not include the tag associated with previous word ‘c’.

Method 300 may then advance to stage 335 where computing device 400 may assign a semantic tag based on the trained statistical model to the possible recognized words in the word lattice to create a word-tag pair for each. For example, the word lattice expanded in stage 325 may be provided to language understanding component 124. Each tag may comprise meta-data associated with the possible recognized word such as a categorization and/or a link to relevant external data. For example, a possible recognized word of ‘nearby’ may be tagged with location coordinates of the user and/or a likely distance radius from the user's current location to apply to any resulting actions from the interpreted word sequence.

Method 300 may then advance to stage 340 where computing device 400 may calculate a tag probability for each tag associated with each of the possible recognized words. As in stage 330, a tag probability may take into account not only the word being tagged but the context associated with a previous and/or a next word in a given word sequence.

Method 300 may then advance to stage 345 where computing device 400 may calculate a joint probability for each word-tag pair in the word lattice. For example, this joint probability may comprise a combination of the recognition probability and the tag probability. Weighting between the two probabilities may be configurable and/or may be dynamically adjusted according to heuristic learning algorithms. At every arc of the word lattice, information about the best incoming transition may be stored.

Method 300 may then advance to stage 350 where computing device 400 may select a most-likely word-tag sequence for the converted acoustic signal according to a best path. For example, a Viterbi best path may be identified by backtracking the best transitions between word-tag pairs according to the joint probability for each word-tag pair in the word lattice. Method 300 may then end at stage 360.

An embodiment consistent with the invention may comprise a system for providing joint decoding of words and tags. The system may comprise a memory storage and a processing unit coupled to the memory storage. The processing unit may be operative to receive an input from a user comprising a plurality of elements, decode the input into a word lattice comprising a plurality of words, assign a tag to each of the plurality of words, identify a most-likely sequence of word-tag pairs, and evaluate the most-likely sequence of node-tag pairs as an action request from the user.

Another embodiment consistent with the invention may comprise a system for providing joint decoding of words and tags. The system may comprise a memory storage and a processing unit coupled to the memory storage. The processing unit may be operative to receive a spoken input from a user comprising a plurality of words, identify at least one possible recognized word for each of the plurality of words via a speech recognition module, create a word lattice comprising each possible recognized word, identify a tag for each possible recognized word via an understanding module, and select a most-likely sequence of word-tag pairs.

Yet another embodiment consistent with the invention may comprise a system for providing joint decoding of words and tags. The system may comprise a memory storage and a processing unit coupled to the memory storage. The processing unit may be operative to train a statistical model for a plurality of tag posterior probabilities, receive an input from a user, convert the input into a word lattice, expand the word lattice to eliminate ambiguity between possible words, and calculate recognition probabilities for each possible word. The processing unit may be further operative to assign a tag to each possible word, calculate a tag probability for each tag, calculate a joint probability according to the recognition probability and the tag probability, and select a most-likely word sequence from among the possible word-tag pairs.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 3 and the associated descriptions provide a discussion of a variety of operating environments in which embodiments of the invention may be practiced. However, the devices and systems illustrated and discussed with respect to FIG. 3 are for purposes of example and illustration and are not limiting of a vast number of computing device configurations that may be utilized for practicing embodiments of the invention, described herein.

With reference to FIG. 3, a system consistent with embodiments of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include input understanding architecture 120. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, a capture device, etc. A capture device may be operative to record a user and capture spoken words, motions and/or gestures made by the user, such as with a camera and/or microphone. The capture device may comprise any speech and/or motion detection device capable of detecting the speech and/or actions of the user. For example, the capture device may comprise a Microsoft® Kinect® motion capture device comprising a plurality of cameras and a plurality of microphones. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 may perform processes and/or methods as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each and/or many of the components illustrated above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any component of operating environment 100 may operate via application-specific logic integrated with other components of the computing device/system on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing joint decoding of words and tags, the method comprising:
receiving an input from a user comprising a plurality of elements;
decoding the input into a word lattice comprising a plurality of words;
assigning a tag to each of the plurality of words;
identifying a most-likely sequence of word-tag pairs; and
evaluating the most-likely sequence of word-tag pairs as an action request from the user, wherein evaluating the most-likely sequence of word-tag pairs as the action request comprises providing a result of the action request as an output to the user.

2. The method of claim 1, wherein the input comprises at least one of the following: a spoken input, a text input, and a gesture.

3. The method of claim 1, wherein each of the plurality of words comprises an unambiguous left context and an unambiguous right context.

4. The method of claim 3, wherein the word lattice comprises an acyclic word graph comprising a plurality of arcs connecting the plurality of words.

5. The method of claim 4, wherein decoding the input into the word lattice comprises splitting each of the plurality of words and merging any of the plurality of arcs comprising a common sub-sequence of a configurable length in a topological order.

6. The method of claim 5, wherein the configurable length is less than 4.

7. The method of claim 5, wherein decoding the input into the word lattice further comprises:
reversing the word lattice obtained by splitting each of the plurality of words,
splitting each of the plurality of words and merging any of the plurality of arcs comprising a common sub-sequence of a configurable length in the topological order, and
reversing the word lattice to its previous orientation.

8. The method of claim 1, further comprising calculating a probability for a word associated with each of the plurality of words.

9. The method of claim 8, wherein the probability is associated with a recognition of each of a plurality of elements associated with the input.

10. The method of claim 9, further comprising calculating a probability for each tag assigned to each of the plurality of words.

11. The method of claim 10, wherein identifying the most-likely sequence of word-tag pairs comprises:
identifying a joint probability for each word-tag pair according to the probability assigned to the word associated with each of the plurality of words and the probability assigned to each tag assigned to each of the plurality of words; and
selecting a sequence of word-tag pairs comprising a highest joint probability for each element of the input.

12. A system for providing joint decoding of words and tags, the system comprising:
a memory storage; and
a processing unit coupled to the memory storage, wherein the processing unit is operable to:
receive a spoken input from a user comprising a plurality of words,
identify at least one possible recognized word for each of the plurality of words via a speech recognition module,
create a word lattice comprising each possible recognized word,
identify a tag for each possible recognized word via an understanding module, and
select a most-likely sequence of word-tag pairs.

13. The system of claim 12, wherein the processing unit is further operative to calculate a probability for each possible recognized word.

14. The system of claim 13, wherein the processing unit is further operative to calculate a probability for each tag.

15. The system of claim 14, wherein the probability calculated for each tag is associated with a context derived from at least one neighboring word in the word lattice.

16. The system of claim 15, wherein the at least one neighboring word comprises at least one of the following: a previous word and a future word.

17. The system of claim 14, wherein the processing unit is further operative to learn a probability for each of a plurality of possible tags according to a context associated with each of a plurality of previous, current, and future words.

18. The system of claim 14, wherein being operative to select the most-likely sequence of word-tag pairs comprises being operative to:
calculate a joint-probability for each word according to the probability assigned to each possible recognized word and the probability assigned to each tag; and
select the most-likely sequence according to a highest joint-probability for each word-tag pair.

19. The system of claim 12, wherein the processing unit is further operative to ignore at least one silence element in the spoken input.

20. A computer-readable medium which stores a set of instructions which when executed performs a method for providing joint decoding of words and tags, the method executed by the set of instructions comprising:
training a statistical model with a plurality of tag probabilities according to a plurality of contexts associated with a plurality of current, past, and future words and tags assigned to each of the plurality of current, past, and future words, wherein the statistical model comprises a maximum entropy model;
receiving an input from a user, wherein the input comprises an acoustic signal comprising a plurality of spoken words;
converting the acoustic signal to a word lattice via an automatic speech recognizer, wherein the word lattice comprises at least one possible recognized word for each of the plurality of spoken words;
expanding the word lattice to comprise a plurality of arcs connecting each of the at least one possible recognized words in a plurality of possible word sequences such that each of the at least one possible recognized words is associated with an unambiguous left context and an unambiguous right context;
calculating a recognition probability for each of the at least one possible recognized words according to a recognition context associated with at least one of the following: a previous possible recognized word in at least one of the plurality of possible word sequences and a next possible recognized word in the at least one of the plurality of possible word sequences;
assigning a tag based on the trained statistical model to each of the at least one possible recognized words in the word lattice to create a word-tag pair for each of the at least one possible recognized words in the word lattice;
calculating a tag probability for each tag associated with each of the at least one possible recognized words in the word lattice according to a tag context associated with at least one of the following: a tag associated with a previous possible recognized word in at least one of the plurality of possible word sequences and a tag associated with a next possible recognized word in the at least one of the plurality of possible word sequences;
calculating a joint probability for each word-tag pair in the word lattice; and
selecting a most-likely word sequence for the converted acoustic signal according to a best path associated with the joint probability for each word-tag pair in the word lattice.
